(19) United States
(12) Patent Application Publication
(10) Pub. No.: US 2017/0028315 A1
(43) Pub. Date: Feb. 2, 2017

(54) Leaching Vessel System and Method

(71) Applicants: Steven F. Baugh, Broomfield, CO (US); Michael S. Turcotte, Denver, CO (US); Linn D. Havelick, Arvada, CO (US)

(72) Inventors: Steven F. Baugh, Broomfield, CO (US); Michael S. Turcotte, Denver, CO (US); Linn D. Havelick, Arvada, CO (US)

(21) Appl. No.: 15/162,592

(22) Filed: May 23, 2016

Related U.S. Application Data
(60) Provisional application No. 62/165,920, filed on May 23, 2015.

(51) Int. Cl. B01D 11/02

(52) U.S. Cl. CPC B01D 11/0219

(57) ABSTRACT

A leaching vessel system and method for extracting oils from plant material is provided. The leaching vessel distribution and emptying system of the present invention is configured to avoid and prevent many of the inherent problems with conventional leaching methods, including channeling, excess compaction of feed, plugging, and the like. The leaching vessel can include modular nested sections having a main stem and one or more spaced screens or like structures adapted for housing within a vessel main body.

### PRIORITY

This Application claims priority to and the benefit of U.S. Provisional Patent Application No. 62/165,920, filed May 23, 2015, which is incorporated fully herein by reference.

### FIELD OF THE INVENTION

The present invention relates generally to plant matter processing and, more specifically, to systems, devices, and methods for extracting oils from plant material via a leaching vessel assembly and process.

### BACKGROUND OF THE INVENTION

Leaching is the process of extracting oils and such from a solid plant material, which can result in a final liquid product. The process is facilitated with the use of various solvents. Typically, a leaching procedure will implement a container referred to as a leaching vessel. The plant matter (e.g., feed) is placed into the core volume of the leaching vessel and is introduced wet or otherwise saturated. After a period of time (e.g., contact time) the solvent is removed from the vessel, thereby separating the solvent from the feed. The leached feed (e.g., spent feed) remains in the leaching vessel after removal of the introduced solvent.

There are several challenges inherent with this conventional leaching procedure. As the solvent flows through the feed material, it may follow limited flow paths (e.g., channeling, or paths of least resistance). Channeling may occur for many reasons, including the composition of the feed, the size of the feed particles, the moisture content of the feed particles, the density of the feed, or due to packing of the feed into the leaching vessel. Channeling is problematic because it reduces the effectiveness of the leaching procedure—portions of the feed are either not wetted or do not remain in contact with the solvent for an appropriate contact time. Furthermore, channeling may occur with or without complete or partial plugging of the leaching vessel, which can likewise reduce the flow rate of solvent through the feed.

During the leaching procedure, the feed may be compacted in several ways, including at the time the feed is introduced to the leaching vessel, compacted by settling when wetted compression is introduced by a filtration process (e.g., compression), or feed/solvent interaction (e.g., wetting). The spent feed may adhere to the body or walls of the leaching vessel in varying degrees through wetting of the spent feed and leaching vessel body.

Getting even flow through a packed column, extraction vessel is a difficult task. Often times the plant material is ground to a consistent particle size to ensure even flow. With some material the compounds of interest are on the surface and they stick to the grinding apparatus causing increased cleaning and process losses. Normally, flow through a packed column will channel, picking the path of least resistance through the bulk material.

Currently, the operator cannot see the channeling taking place in the stainless steel vessels. Because of this the standard practice is to flood the extraction chamber with solvent and let the material soak in the solvent to ensure solvent contact with all material and efficient extraction. Flooding the chamber takes more solvent and increases the penetration of the solvent into the material, causing extraction of more waxes, lipids and chlorophyll.

Additionally, using additional solvent causes longer cycle times because of the soak time versus continuous flow and the increased solvent recovery. Solvent recovery is the longest part of the extraction process and in a butane example; 2 gallons of butane are required for the soak.

Upon completion of the leaching procedures, the leaching vessel is opened and turned upside down so that the top of the leaching vessel is facing downward. Conventionally, the leaching vessel is tapped, bumped, shaken, poked with a stick, or otherwise disrupted to get the spend feed out of the vessel. The problems of channeling, compaction, plugging and inconsistent contact are common in conventional leaching vessels. Furthermore, emptying of the leaching vessel is commonly difficult due to these problems, as well as drying of the feed and adherence of the feed to the walls of the leaching vessel.

### SUMMARY OF THE INVENTION

The present invention provides an improved leaching vessel system and method. The leaching vessel distribution and emptying system of the present invention is configured to avoid and prevent many of the inherent problems with conventional leaching methods, including channeling, excess compaction of feed, plugging, and the like. As such, a consistent contact of feed within the system is achieved.

The leaching vessel of the present invention can include a main stem and one or more spaced screens or like structures. The plurality of screens can include a top screen, one or more intermediate screens, and a bottom screen. In various embodiments, one or more of the screens can be constructed of a mesh material. However, other embodiments of the screens can be perforated materials, of varying sizes, shapes, numbers, and spaced configurations. The screens may be attached to the main stem of the vessel assembly by any means—such as by welding, supports, threaded nuts, snap features, and the like. Other means of support or securement for the screens implemented with the present invention can include resting ledges, tabs, grooves, etc. The top screen can be located at a distance below the top of the main stem in certain embodiments to allow the top end of the main stem to function as a handle for placement or removal of the assembly.

### BRIEF DESCRIPTION OF THE DRAWINGS

FIGS. 1-4 depict a leaching vessel assembly, in accordance with embodiments of the present invention.

FIGS. 5-7 depict a modular nested distribution and emptying vessel assembly, in accordance with embodiments of the present invention.

FIGS. 8-10 depict a modular nested distribution and emptying vessel assembly having a tapered bottom section, in accordance with embodiments of the present invention.

FIGS. 11-12 depict a modular nested distribution and emptying vessel assembly with exemplary callouts, in accordance with embodiments of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION OF EXAMPLE EMBODIMENTS

In the following descriptions, the present invention will be explained with reference to example embodiments thereof. However, these embodiments are not intended to limit the present invention to any specific example, embodiment, environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

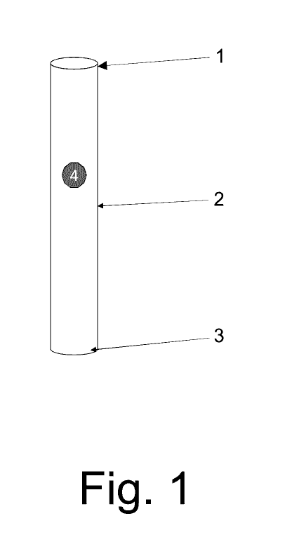

Referring generally to FIGS. 1-10, the devices, assemblies, and methods for a leaching vessel system 4 are provided. Leaching is the process of extracting oils and such from a solid plant material, which can result in a final liquid product. The process is facilitated with the use of various extracting agents (such as but not limited to solvents). Embodiments of the present invention can be employed to prevent channeling, excess compaction of feed, plugging, and other undesirable effects that plague conventional leaching vessels. Applicable solvents can include any solvents known to those of skill in the art, including, butane, alcohol, supercritical fluid, and the like. The agents or solvents promote even distribution of the bulk to be extracted, while helping to remove the spent material from the tube (e.g., tapered) when finished. Oils from seeds, marijuana, leafy plants, grains (e.g., flax and tea trees), and essential oils from lavender flowers, hops, mint, and other plant materials can be extracted using the present invention.

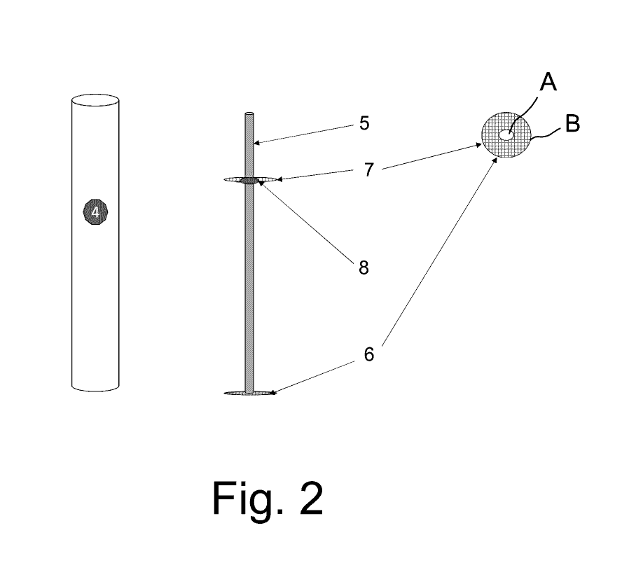

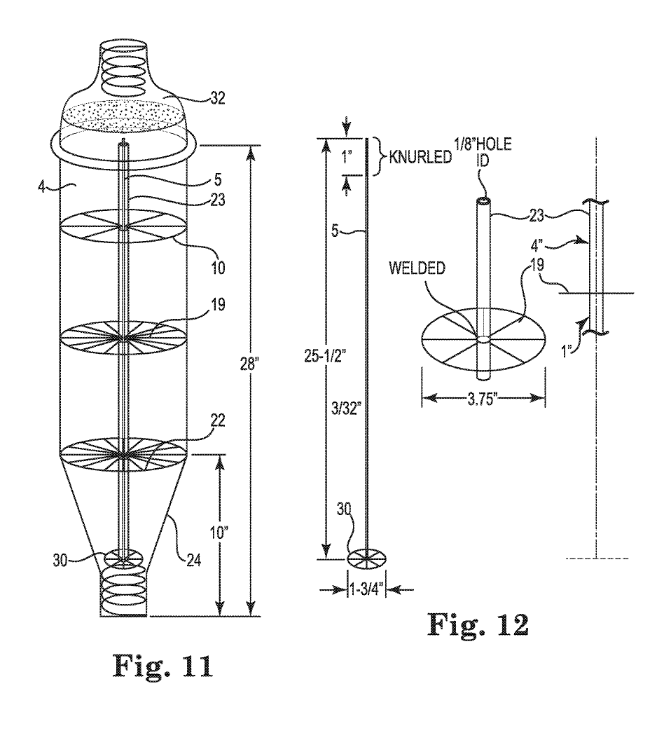

As shown in FIGS. 1-2, a basic leaching vessel 4 in accordance with embodiments of the present invention can include a vessel body 2, a vessel top assembly 1, a vessel bottom assembly 3, combining to form a vessel core volume 4. Further, the vessel 4 can include a main stem 5, a bottom screen 6, a top screen 7, and a top screen support 8. The screens may have inner openings A that are designed to receive the stem 5 and, in some embodiments, to permit the screens to move along a length of the stem 5. The screens also have an outer perimeter B that is in operative communication with an inner surface of the vessel 4. In some embodiments, the distance between the outer perimeter B of the screens and the inner surface of the vessel may vary depending upon the particular leaching process needs. In one example embodiment, as illustrated in FIG. 12, the screens may have a size of approximately 3.75 inches, the vessel 4 may have a length of approximately 28 inches and the stem may have a length of approximately 25.5 inches. A taper bottom section 24 (as illustrated in FIG. 11), may also be provided giving the vessel 4 a length of approximately 28 inches. In an embodiment without the bottom taper section 24 the stem may be 28 inches. Various sizes, shapes and lengths are also contemplated herein and those provided should not be considered limiting.

In various embodiments disclosed herein, one or more of the screens can be constructed of a mesh material. However, other embodiments of the screens can be perforated materials, of varying sizes, shapes, numbers, and spaced configurations. The mesh material can be manufactured from any material type, including but not limited to metal and non-metal materials (e.g., polymers). The screens have pores (e.g., perforations, openings, etc.) that let the solvent flow through. In various embodiments the pore sizes can vary from 10 to 100 microns with some embodiments having pore sizes between 50 and 75 microns. Other pore sizes are also possible depending upon the material, the solvent used and/or the temperature of the solvent or the process.

Embodiments of the present invention can include screens or like devices or structures provided within the vessel 4 without the use of a stem. For instance, tabs, grooves, ledges, or like securement features can be included at locations along the inside of the tubular vessel 4 to secure the screens in place or otherwise serve as a platform rest or engagement surface for the screens. In addition, such securement features can be included with embodiments also having an elongate stem within the vessel 4.

The screens may be attached to the main stem of the vessel assembly by any means—such as by welding, supports, threaded nuts, snap features, and the like. In one embodiment of the invention, one or more of the screens may be removable from the stem 5 to permit cleaning and replacement of the screens. One or more of the screens may also be adjustably positioned along a length of the stem 5 to permit adjustment for varying feed material types (including different feed material sized particles) for the purpose of maximizing the leaching process. The top screen 7 can be located at a distance below the top of the main stem 5 in certain embodiments to allow the top end of the main stem 5 to function as a handle for placement in or removal of the assembly from the vessel 4. In various embodiments the screens may be spaced apart by 12 to 18 inches. Other distances between the screens are also possible depending upon the material, the solvent used, the temperature and like factors.

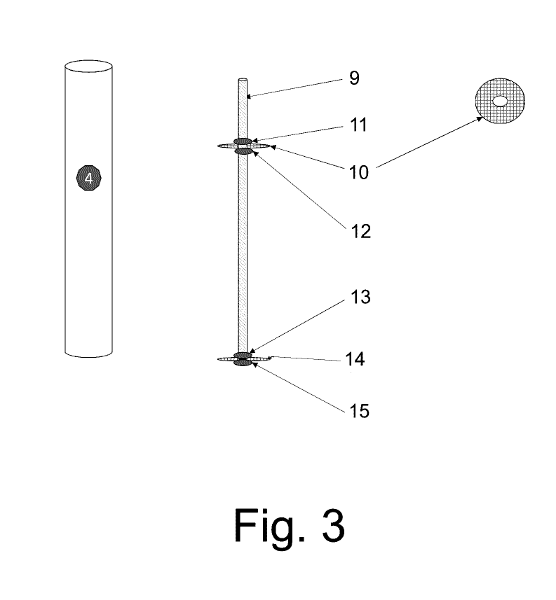

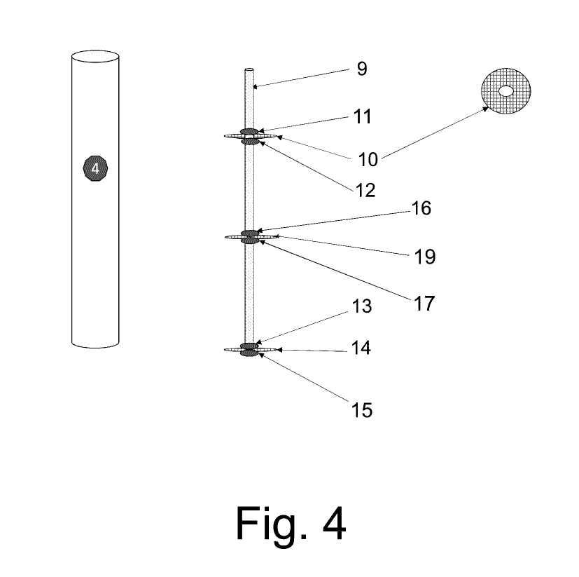

The embodiment of FIGS. 3-4 depict a fluid distribution and emptying vessel assembly with a threaded main stem configuration. The main stem is formed as a threaded rod 9. The screens 10, 14, are secured to the main stem 9 with nuts or like structures, 11, 12, 13, 15, that can be placed on either side of the screens 10, 14 to sandwich or otherwise secure the screens in place. In various embodiments, the nuts are threaded to engage the correspondingly threaded stem rod 9. In addition, an intermediate screen 19 can be included with respective support nuts 16, 17 provided to secure the screen, as shown in FIG. 4. Any number of intermediate screens 19 and spacing configurations can be included between the top screen 10 and the bottom screen 14, depending on the leaching application. In various embodiments the screens may be operatively coupled to the stem by various methods including, welding, supports, pins, and the like.

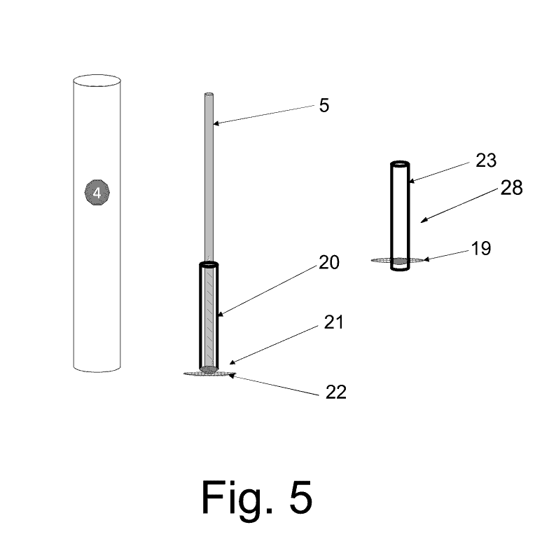

FIGS. 5-10 show embodiments of a nested fluid distribution and emptying vessel assembly. The nested assembly configuration permits for quick placement and positioning of screens within the vessel 4. As illustrated in FIG. 5, the nested assembly configuration may include a bottom screen support 21 and one or more intermediate nested screen supports 28. The nested assembly allows the leaching vessel to be filled incrementally, with any number of intermediate nested screens insertable (e.g., modular application) within the vessel as it is filled. The bottom screen support 21 can include a support tube or spacer 20 and a fixed or adjustably connected screen 22. The intermediate nested screen support can include an intermediate nested tube or spacer 23 and a fixed or adjustably connected screen 19. The support tubes 20 and 23 can have channels extending along their length for operative communication with the stem 5. In various embodiments, the channels and stem 5 may be keyed to facilitate securement and positioning. Additionally, the support tubes 20 and 23 can be of similar or varying lengths to permit variation in placement of the screens within the vessel 4. As a result, screens are placed in any placement configuration to promote proper functionality. In varying embodiments, the support tubes can be telescoping or otherwise adjustable lengthwise to permit further adjustment of the position of the screens within the vessel 4.

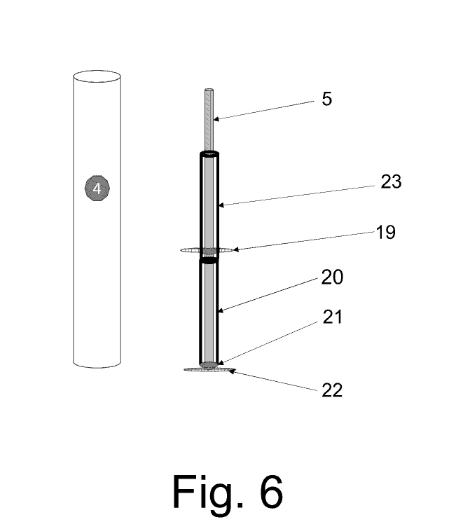

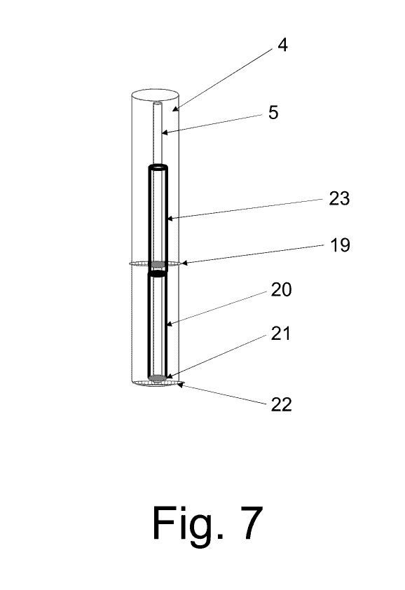

FIG. 6 provides a nested system applied to the main stem 5 (e.g., nesting base tube 20 and intermediate nested tube 23), without yet being placed within the leaching vessel 4. FIG. 7 depicts the nested assembly fully housed within the leaching vessel 4. For example, the main stem 5 can be placed into the leaching vessel 4 first, followed by feed and/or filtration media (e.g., activated carbon, diatomaceous earth, or ion exchange media). Following the placement of feed or filtration media, an intermediate nested screen support 28 section may be placed into vessel 4. Then, additional feed and/or additional filtration media of the same or different types can be included. Again, many levels and configurations of intermediate screens can be employed in this manner, as needed. An end of stem 5 may include a stop to prevent a bottom screen support 21 from traveling beyond an end of the stem 5. Screen support sections can be arranged in any order and with screens of varying configurations.

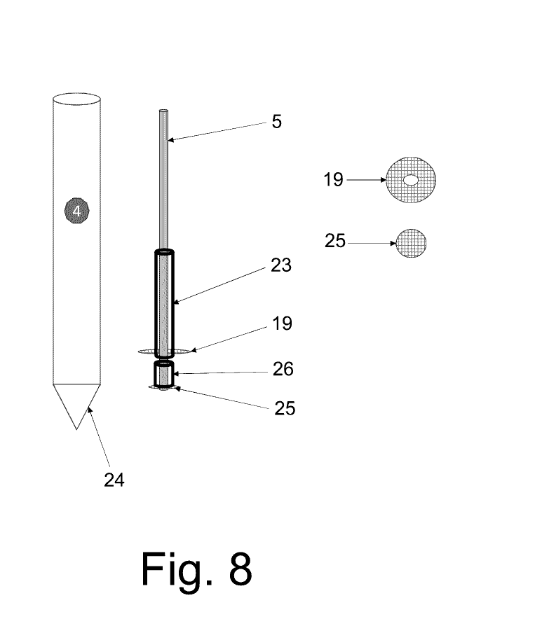

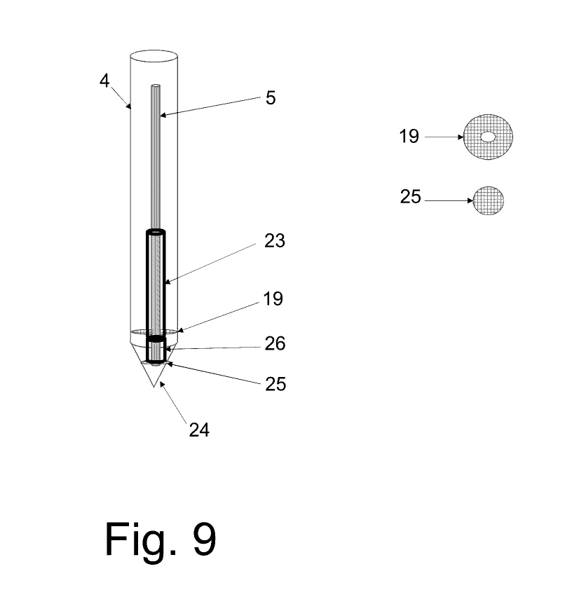

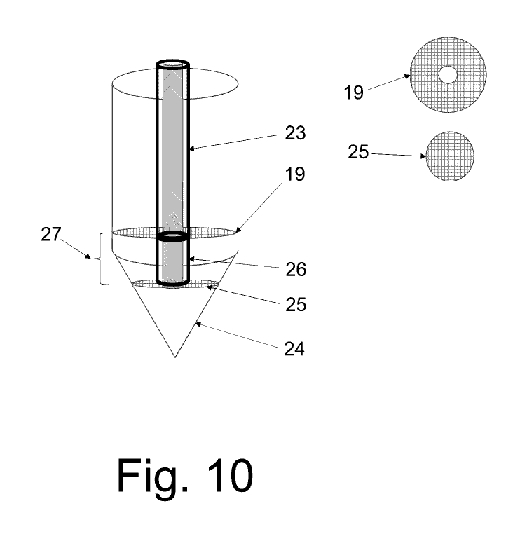

FIGS. 8-10 show a nested vessel configuration having a tapered bottom section 24. The tapered bottom section 24 greatly improves flow and recovery. The taper helps maintain laminar flow and prevents eddy currents from forming in the bottom edges of a straight tube with a small hole in the end. As a result, the present invention provides better extraction efficiency (minimizes channeling with laminar flow) and promotes better recovery because the extract isn't deposited in the slow flow eddy current at the bottom edge of the straight tube. The bottom section 24 can include a base screen 25 that is sized and shaped to fit into the tapered bottom section 24 of the vessel 4. As shown, the base screen 25 can be measurably smaller in diameter than the intermediate screen 19. In a nested configuration a tube 26 is included to fit the length or depth of the tapered tube 24. The size, height, and shape of the nested tubes 23, 26 can be varied to allow for adjustment of the void space or the distance between the screens. FIG. 9 depicts the nested assembly sections incorporated into the tapered leaching vessel 4. FIG. 10 illustrates the void space 27 created between sets of screens. In a typical application of the present invention, the lowermost void space within an assembly can contain a filter media or feed.

FIGS. 11-12 demonstrate an embodiment of the present invention, including various exemplary dimensional and structural callouts for the vessel 4. As depicted, the stem 5 can be knurled, and adapted to insert within various nested tubes (e.g., 23). The stem 5 can include a base 30 to facilitate stability within, and removal from, the vessel 4. A cap or diffuser 32 can also be removably coupled to the vessel 4 to prevent foreign material from entering the vessel 4. The cap 32 also acts to prevent the loss of solvent from within the vessel 4. The cap 32 can have inner or outer threads to be threaded to corresponding inner or outer threads on the vessel 4.

As illustrated in FIG. 12, an example embodiment may have support tube 23 having a length of approximately 4 inches above the screen 19, and a tube length of approximately 1 inch below the screen 19. The tube lengths are provided for illustrative purposes and various tube lengths are also contemplated. The support tubes may have an inner diameter of approximately ⅛ inch that is sized to receive the stem 5. Various sizes and shapes of the stem 5 and tubes are contemplated herein. Various component connections (e.g., with stem 4) can be configured to include attachment nuts, pressure fittings, snap fittings, threading sections, welding, and the like. As detailed herein, the various components and connection methods can vary for certain embodiments without deviating from the spirit and scope of the present invention.

In use, the vessel 4 may be used with or without a tapered tube 24. The process begins with the material being processed in order to obtain a generally uniform or non-uniform particle size. The particle size will impact the extraction process and, therefore, different processes will require varying particle size. Next, the stem 5 may be inserted into the vessel 4 such that a lower screen is positioned near the bottom opening of the vessel 4. A user may then insert the material into the vessel 4. In some embodiments, the user may impart an amount of pressure onto the material for compaction purposes. The user may then insert an intermediate screen 10, 17, or 19, depending upon the embodiment, and then introduce another similar or dissimilar material (such as a filtering agent like carbon). The process may be repeated until the vessel is filled to an appropriate level.

Once the vessel is assembled a user may begin to introduce an extracting agent (such as a solvent) into the vessel. As the extracting agent flows through the vessel it contacts the material thereby extracting the desired chemical, compounds and the like. As the extracting agent flows through the material it contacts the screen and pools above it. This pooling slows down the flow process and ensures wetting of all of the plant material. The pooling agent and increased wetting of the material increases extraction of the chemical and eliminates or reduces channeling allowing for real-time extraction. As can be seen, this process eliminates the need for flooding of the vessel with the agent to ensure material wetting. The pooling and wetting processes continues through each section of material and screen until the agent and chemical combination flows out of the vessel 4. The agent is then processed to obtain the extracted chemical disclosed herein.

The present invention may be embodied in other specific forms without departing from the spirit or essential attributes thereof, and it is, therefore, desired that the present embodiment be considered in all respects as illustrative and not restrictive. Similarly, the above-described methods and techniques for forming the present invention are illustrative processes and are not intended to limit the methods of manufacturing/forming the present invention to those specifically defined herein. A myriad of various unspecified steps and procedures can be performed to create or form the inventive methods, systems and devices.

What is claimed is:

1. A leaching vessel system, comprising:
a generally tubular vessel body including an elongate vessel stem extending along a length within an interior of the vessel body, and a nested platform array having;
a first platform portion connectable with the vessel stem and adapted to hold plant material such that an extracting agent is directed along one or more first fluid flow paths; and
a second platform portion connectable with the vessel stem and spaced from and below the first platform portion to hold plant material such that the extracting agent is directed along one or more second fluid flow paths.

2. The system of claim 1, wherein the generally tubular vessel body portion is generally cylindrical.

3. The system of claim 1, wherein at least one of the first and second platform portions is generally disc-shaped and perforated.

4. The system of claim 1, wherein at least one of the first and second platform portions is constructed of a porous screen material.

5. The system of claim 1, wherein at least one of the first and second platform portions is constructed of a mesh material.

6. The system of claim 1, wherein the one or more platform portions are selectively positionable along the vessel stem to create a modular configuration.

7. The system of claim 1, further including one or more additional platform portions spaced from the first and second platform portions.

8. The system of claim 1, further including a removable vessel top portion.

9. The system of claim 1, further including a vessel bottom portion tapering away from the vessel body to promote extraction efficiency and laminar flow.

10. The system of claim 1, wherein the elongate vessel stem includes a top end portion to facilitate removable of at least the elongate vessel stem and the connected first and second platform portions from the interior of the vessel body.

11. A nested leaching vessel system, comprising:
a generally tubular vessel body having an interior wall surface, and a modular and nested platform array having;
at least one perforated first screen adapted for securement along the interior wall surface to hold plant material such that an extracting agent is directed along one or more first fluid flow paths; and
at least one perforated second screen adapted for securement along the interior wall surface, spaced from the perforated first screen, to hold plant material such that the extracting agent is directed along one or more second fluid flow paths.

12. The system of claim 11, wherein the generally tubular vessel body portion is generally cylindrical.

13. The system of claim 11, further including an elongate stem operably connected to the at least one perforated first screen and the at least one perforated second screen.

14. The system of claim 11, further including one or more additional perforated screens spaced from the at least one perforated second screen.

15. The system of claim 11, further including a removable vessel top portion.

16. The system of claim 11, further including a vessel bottom portion tapering away from the vessel body to facilitate laminar flow.

17. The system of claim 11, further including an elongate vessel stem including a top end portion to facilitate removable of the at least one perforated first screen and the at least one perforated second screen from the interior of the vessel body.

18. The system of claim 11, further including a tapered vessel bottom portion having one or more perforated bottom screens.

19. The system of claim 11, wherein the at least one perforated first screen and the at least one perforated second screen slow and distribute flow of the extracting agent.

20. The system of claim 11, further including at least one interior support tube adapted to support and space the at least one perforated first screen and the at least one perforated second screen.
